(19) United States
(12) Patent Application Publication
(10) Pub. No.: US 2014/0042950 A1
(43) Pub. Date: Feb. 13, 2014

(54) NUMERICAL CONTROLLER WITH MULTICORE PROCESSOR

(71) Applicant: FANUC Corporation, Minamitsuru-gun (JP)

(72) Inventors: Kazunari AOYAMA, Minamitsuru-gun (JP); Kunitaka KOMAKI, Minamitsuru-gun (JP)

(73) Assignee: FANUC Corporation, Minamitsuru-gun (JP)

(21) Appl. No.: 13/955,178

(22) Filed: Jul. 31, 2013

(30) Foreign Application Priority Data
Aug. 7, 2012 (JP) 2012-174832

(51) Int. Cl. G05B 19/414

(52) U.S. Cl. CPC G05B 19/4148
USPC 318/569

(57) ABSTRACT

A numerical controller includes a multicore processor, an integrated peripheral control LSI, a motor control section and an amplifier interface section. The multicore processor has two cores. One is assigned as a numerical control section processor core, and the other is assigned as a programmable machine controller section processor core. The motor control section is composed of a motor control section processor and a peripheral control LSI.

### BACKGROUND OF THE INVENTION

1. Field of the Invention

The present invention relates to a numerical controller for controlling a machine tool or an industrial machine.

2. Description of the Related Art

A numerical controller for controlling a machine tool or an industrial machine includes various functional blocks of a numerical control section, a motor control section, a PMC (Programmable Machine Controller) section and the like, as disclosed in Japanese Patent Application Laid-Open No. 9-69004. These functional blocks are interconnected via a bus. An example of the configuration of a conventional numerical controller will be described with reference to FIG. 1.

A numerical controller 10 shown in FIG. 1 includes a functional block of a numerical control section 11, a functional block of a PMC section 12, a functional block of a motor control section 13, and a functional block of an amplifier interface section 14. These functional blocks are connected to each other via an internal bus 15.

Processors 20, 30 and 40 and peripheral control LSIs 22, 32 and 42 are mounted on the functional blocks of the numerical control section 11, the PMC section 12 and the motor control section 13, respectively. The processors 20, 30 and 40 execute processing to control the corresponding functional blocks, and the peripheral control LSIs 22, 32 and 42 serve as respective bridges between the processors 20, 30 and 40 and the internal bus 15. DRAMs 21 and 31 are also mounted on the functional blocks of the numerical control section 11 and the PMC section 12, respectively. A communication control LSI 50 is mounted on the functional block of the amplifier interface section 14.

The processor 20 of the numerical control section 11 plays a role of main processor of the whole numerical controller 10. The numerical control section 11 (processor 20) reads calculation results from the PMC section 12 and the motor control section 13 via the internal bus 15 and writes results of calculations calculated based on the read calculation results to the PMC section 12 and the motor control section 13 via the internal bus 15, for each interrupt that occurs at a constant frequency. Note that from/to which the numerical control section 11 reads/writes a calculation result may be the DRAM 21 of the numerical control section 11 or the DRAM 31 of the PMC section 12 or may be one of RAMs incorporated in the peripheral control LSIs 22, 32, and 42 mounted on the functional blocks of the numerical control section 11, the PMC section 12 and the motor control section 13. Note that, in the functional blocks of the numerical control section 11, the PMC section 12 and the motor control section 13, the processors 20, 30 and 40 are connected to the peripheral control LSIs 22, 32, and 42, respectively, by buses of 8 to 64 bits according to the functions of the processors 20, 30 and 40.

The numerical control processor 20 that calculates a command to move a motor and the sequence control processor 30 that controls a peripheral device are mounted on the numerical controller 10, and the numerical control processor 20 and the sequence control processor 30 are connected to the dedicated peripheral control LSIs 22 and 32, respectively, by the processor-specific buses 23 and 33 of 64 bits and 32 bits, respectively.

Since circuits available for peripheral control LSIs have been increasing along with the increase in the degree of semiconductor integration, it is conceivable to achieve cost reduction by integrating respective peripheral control LSIs mounted on a plurality of functional blocks. In this case, however, a plurality of processors are connected to an integrated peripheral control LSI, which results in the need for the peripheral control LSI to have a large number of I/O pins. If the number of I/O pins required exceeds the number of I/O pins that can be accommodated in an assumed package of the peripheral control LSI, integration of peripheral control LSIs is difficult to achieve (see FIG. 2).

### SUMMARY OF THE INVENTION

In order to solve the above-described problem, the object of the present invention is to provide a numerical controller with a multicore processor that includes a multicore processor into which separate numerical and sequence control processors are integrated as ones of a plurality of cores mounted on a single processor, has reduced the number of pins of peripheral control LSI by connecting the processor (multicore processor) and the peripheral control LSI via a high speed serial bus, and has achieved integration of peripheral control LSIs and cost reduction.

A numerical controller according to the present invention includes a numerical control section, a programmable machine controller section and a motor control section, the numerical control section executes a numerical control program and outputs a command for servo motor control to the motor control section, and the programmable machine controller section executes a predetermined sequence control program on the basis of input data from the numerical control section and input data from a machine which is to be controlled by the numerical controller, notifies the numerical control section of an execution result of the sequence control program, and controls the machine on the basis of the execution result. The numerical controller further includes a multicore processor having a plurality of cores. The numerical control section that executes the numerical control program is assigned to at least one of the plurality of cores of the multicore processor, and the programmable machine controller section that executes the sequence control program is assigned to at least one of the other cores.

The numerical controller may include a peripheral control LSI, and a serial bus may be used as an interface between the peripheral control LSI and the multicore processor.

According to the present invention, a numerical controller with a multicore processor can be provided that includes a multicore processor into which separate numerical and sequence control processors are integrated as ones of a plurality of cores mounted on a single processor, has reduced the number of pins of a peripheral control LSI by connecting the processor (multicore processor) and the peripheral control LSI via a high speed serial bus, and has achieved integration of peripheral control LSIs and cost reduction.

### BRIEF DESCRIPTION OF THE DRAWINGS

The above-mentioned and other objects and features of this invention will become apparent by reference to the following description of the embodiments taken in conjunction with the accompanying drawings, in which:

FIG. 1 is a diagram for explaining the configuration of a conventional numerical controller;

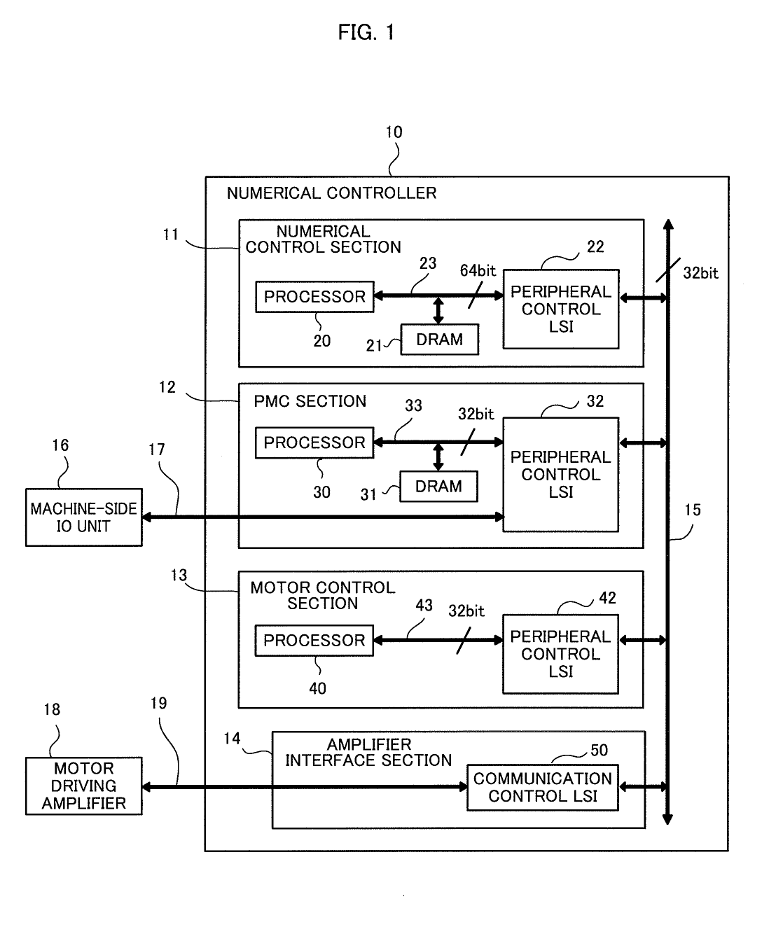

FIG. 2 is a diagram showing the configuration of a conventional numerical controller for explaining the problem to be solved by the present invention;

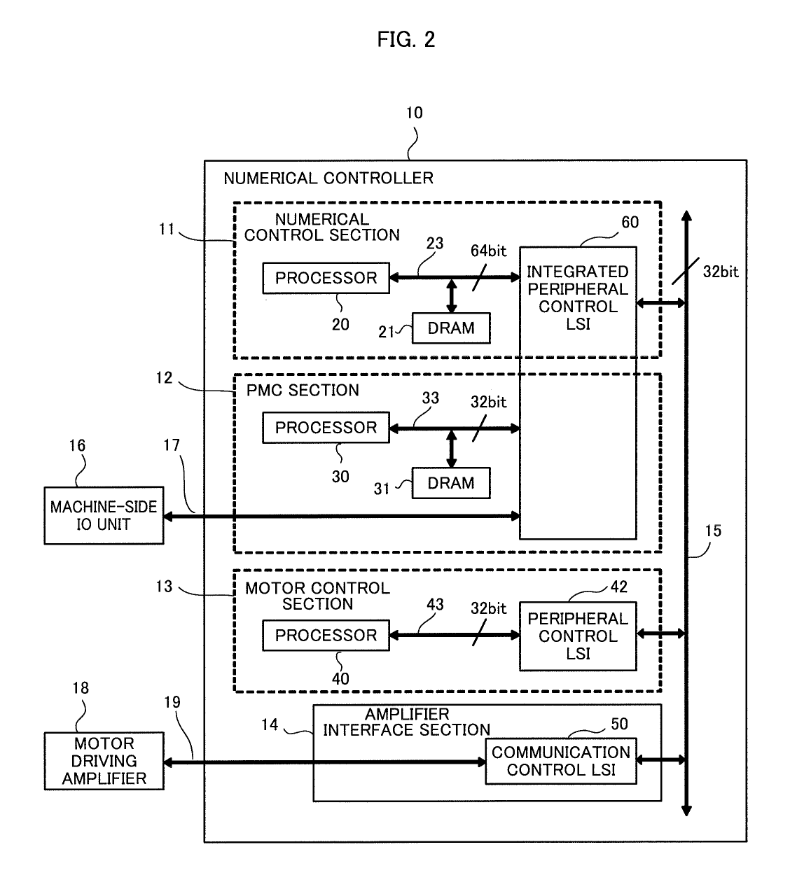

FIG. 3 is a diagram for explaining a numerical controller according to a first embodiment of the present invention which uses a multicore processor and an integrated peripheral control LSI; and

FIG. 4 is a diagram for explaining a numerical controller according to a second embodiment of the present invention in which a multicore processor and an integrated peripheral control LSI are connected via a high speed serial bus.

### DETAILED DESCRIPTION OF THE PREFERRED EMBODIMENTS

Multicore technology has recently been applied to a processor which is connected to an integrated peripheral control LSI. This allows a plurality of cores arranged in a single processor to execute processing. The present invention achieves integration of peripheral control LSIs by applying such multicore processor technology to the architecture of a numerical controller for controlling a machine tool, an industrial device or the like. That is, integration of respective peripheral control LSIs required for a functional block for numerical control and a functional block for PMC control is achieved by assigning a numerical control function and a PMC control function which have been heretofore executed by separate processors to a plurality of cores of a multicore processor and executing the functions.

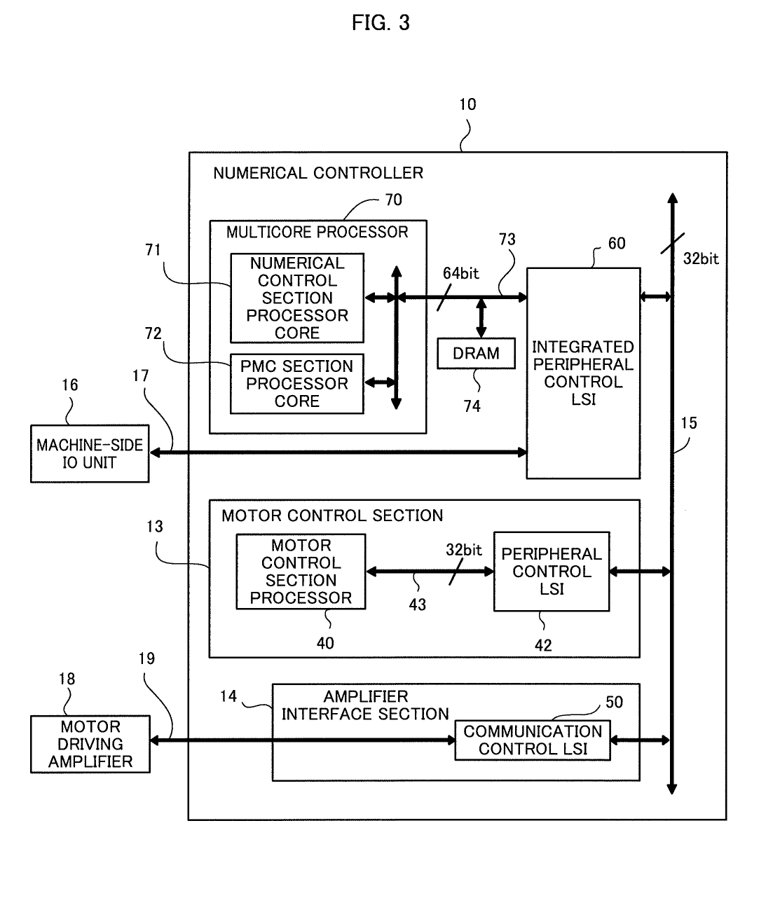

A numerical controller according to a first embodiment of the present invention which uses a multicore processor and an integrated peripheral control LSI will be described with reference to FIG. 3.

A multicore processor 70, an integrated peripheral control LSI 60, a motor control section (servo control section) 13 and an amplifier interface section 14 are mounted on a numerical controller 10, and these sections are connected by an internal bus 15. Two cores are mounted on the multicore processor 70. One is assigned as a numerical control section processor core 71, and the other is assigned as a PMC section processor core 72. The motor control section 13 comprises a motor control section processor 40 and a peripheral control LSI 42. The amplifier interface section 14 performs communication between the numerical controller 10 and a motor driving amplifier 18 which is connected to the amplifier interface section 14 via a serial servo bus 19.

In the numerical control section processor core 71, a command value for controlling the motor driving amplifier 18 is created on the basis of a numerical control program. The created command value is transmitted to an internal RAM (not shown) of the peripheral control LSI 42 of the motor control section 13 via the integrated peripheral control LSI 60 and the internal bus 15.

In the motor control section processor 40 of the motor control section 13, the command value written in the internal RAM of the peripheral control LSI 42 is read, and data for motor control to be transmitted to the motor driving amplifier 18 is created on the basis of the command value. The created data for motor control is written to an internal RAM (not shown) of a communication control LSI 50 of the amplifier interface section 14 via the internal bus 15.

In the communication control LSI 50 of the amplifier interface section 14, the data written in the internal RAM is transmitted to the motor driving amplifier 18 via the serial servo bus 19, which causes the motor driving amplifier 18 to drive a motor (not shown) provided in a machine tool.

In the PMC section processor core 72 of the multicore processor 70, a predetermined sequence control program is executed on the basis of input data from the numerical control section processor core 71 and input data from a machine (not shown) which is obtained via a field bus 17 connected to a machine-side IO unit 16. The numerical control section processor core 71 is notified of an execution result, and signals for controlling machine elements of the machine are transmitted to the machine-side IO unit 16 via the field bus 17 on the basis of the execution result.

If a plurality of cores are mounted on a processor, and the cores perform conventional numerical control and PMC processing, the traffic on a bus between the processor and an integrated peripheral control LSI is expected to be heavier than a conventional traffic, which may degrade the performance of a numerical controller. As a technique for overcoming such problem, high speed serial bus technology, exemplified by PCI Express, has recently become available that can exchange large amounts of data as high speed serial signals.

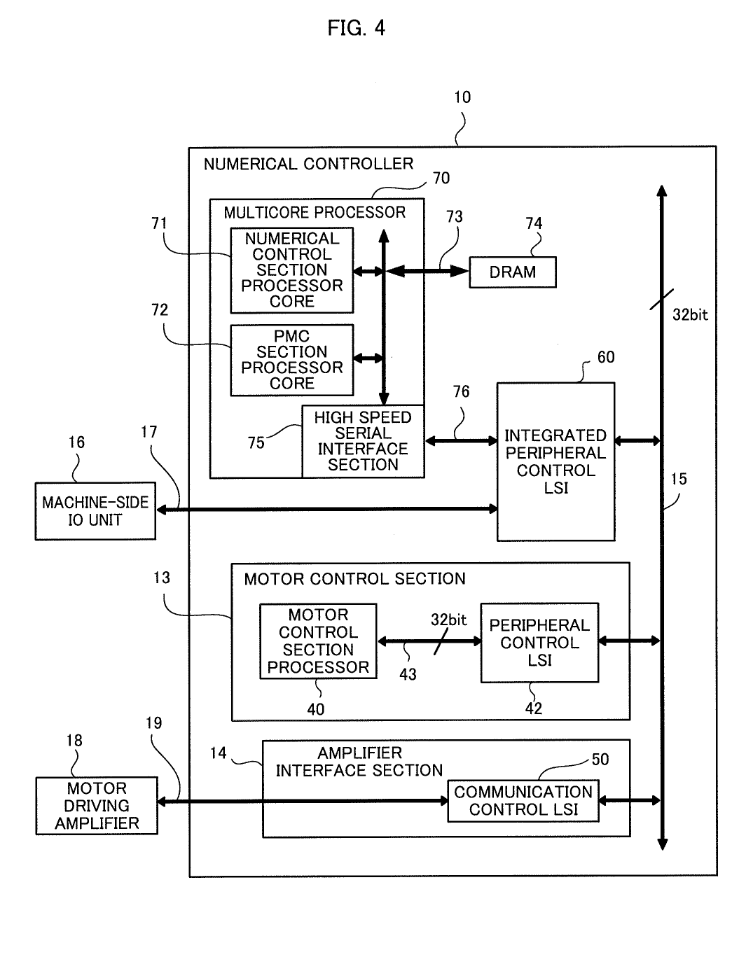

FIG. 4 is a diagram for explaining a numerical controller according to a second embodiment of the present invention in which a multicore processor 70 and an integrated peripheral control LSI 60 are connected via a high speed serial bus 76.

In a numerical controller 10 in FIG. 4, the multicore processor 70 includes a high speed serial interface section 75. The multicore processor 70 is connected to the integrated peripheral control LSI 60 via the high speed serial bus 76 that is connected to the high speed serial interface section 75. In the numerical controller 10, numerical control processing to be performed by the numerical controller 10 is assigned to one core 71 of the multicore processor 70, and PMC control processing is assigned to another core 72 of the multicore processor 70. The assignment reduces the number of IO pins required for connecting a numerical control processor and a PMC control processor to a peripheral control LSI. Additionally, the configuration in which a bus between the multicore processor 70 and the integrated peripheral control LSI 60 is the high speed serial bus 76 allows integration of peripheral control LSIs without degrading the performance of the numerical controller 10. It is thus possible to reduce the cost of the numerical controller 10.

1. A numerical controller comprising a numerical control section, a programmable machine controller section and a motor control section,
wherein the numerical control section executes a numerical control program and outputs a command for servo motor control to the motor control section,
the programmable machine controller section executes a predetermined sequence control program on the basis of input data from the numerical control section and input data from a machine which is to be controlled by the numerical controller, notifies the numerical control section of an execution result of the sequence control program, and controls the machine on the basis of the execution result,
the numerical controller includes a multicore processor having a plurality of cores, and
the numerical control section that executes the numerical control program is assigned to at least one of the plurality of cores of the multicore processor, and the programmable machine controller section that executes the sequence control program is assigned to at least one of the other cores.

2. The numerical controller according to claim 1, wherein the numerical controller includes a peripheral control LSI,
and a serial bus is used as an interface between the peripheral control LSI and the multicore processor.
